(19) United States
(12) Patent Application Publication
(10) Pub. No.: US 2025/0156702 A1
(43) Pub. Date: May 15, 2025

(54) SYSTEMS AND METHODS FOR GENERIC FEATURE SUPPRESSION AND MINIMAL UTILITY PRESENTATION FROM MULTI-ATTRIBUTE DATA

(71) Applicant: JPMORGAN CHASE BANK, N.A., New York, NY (US)

(72) Inventors: Yizhuo CHEN, Champaign, IL (US); Richard CHEN, Baldwin Place, NY (US); Hsiang HSU, Boston, MA (US); Shaohan HU, Yorktown Heights, NY (US); Marco PISTOIA, Amawalk, NY (US)

(21) Appl. No.: 18/506,017

(22) Filed: Nov. 9, 2023

(51) Int. Cl. G06N 3/08

(52) U.S. Cl. CPC G06N 3/08

(57) ABSTRACT

A method may include: accepting, by a data transformation module, an original dataset as input to a first and a second neural network and outputting a transformed dataset; accepting, by a sensitive attribute suppression module, the transformed dataset as input to a third neural network and calculating a sensitive attribute suppression loss; accepting, by an annotated useful attribute preservation module, the transformed dataset as input to a fourth neural network and calculating a useful attribute preservation loss; accepting by a generic feature suppression module, parameters of a distribution of a latent variable from the first neural network and calculating, for an unannotated generic attribute, a generic feature suppression loss; combining the sensitive attribute suppression loss, the useful attribute preservation loss, and the generic feature suppression loss into a total loss; and training the first neural network and the second neural network with the total loss.

### BACKGROUND OF THE INVENTION

### 1. Field of the Invention

Embodiments generally relate to systems and methods for generic feature suppression and minimal utility presentation from multi-attribute data.

### 2. Description of the Related Art

Rapid advances in the fields of artificial intelligence and machine learning (AI/ML) are highly attributable to the growing richness of the datasets used in these fields. For example, studies have shown that models (e.g., machine learning models) trained on larger datasets offer better generalization and are more effectively applied to downstream applications. There are, however, ethical concerns with respect to individual privacy and personal data when using large datasets in AI/ML operations. Many, if not most, large datasets contain such sensitive data as personally identifiable information, medical information, financial information, etc. Therefore, the data owners would oftentimes withhold or simply obfuscate the data, which may seriously decrease the utility of the released data.

### SUMMARY OF THE INVENTION

Systems and methods for generic feature suppression and minimal utility presentation from multi-attribute data are disclosed. In one embodiment, a method may include: (1) executing a machine learning model on at least one computer comprising a processor and a memory; (2) providing a data transformation module of the machine learning model, wherein the data transformation module accepts an original dataset as input to a first neural network and a second neural network and outputs a transformed dataset; (3) providing a sensitive attribute suppression module of the machine learning model, wherein the sensitive attribute suppression module accepts the transformed dataset as input to a third neural network and calculates, for each attribute of a plurality of annotated sensitive attributes, a sensitive attribute suppression loss; (4) providing an annotated useful attribute preservation module of the machine learning model, wherein the annotated useful attribute preservation module accepts the transformed dataset as input to a fourth neural network, and calculates, for each attribute of a plurality of annotated useful attributes, a useful attribute preservation loss; (5) providing a generic feature suppression module of the machine learning model that accepts parameters of a distribution of a latent variable from the first neural network and calculates, for an unannotated generic attribute, a generic feature suppression loss; (6) combining the sensitive attribute suppression loss, the useful attribute preservation loss, and the generic feature suppression loss into a total loss; and (7) training the first neural network and the second neural network with the total loss.

In one embodiment, the third neural network may be trained jointly with the training of the first neural network and the second neural network using the sensitive attribute suppression loss, and the third neural network may be trained using supervised learning.

In one embodiment, the first neural network may be trained using gradient descent.

In one embodiment, the sensitive attribute suppression loss may be a constraint to an estimation of mutual information between each attribute of the plurality of annotated sensitive attributes and the transformed dataset.

In one embodiment, the useful attribute preservation loss may be a constraint to an estimation of mutual information between each attribute of a plurality of annotated useful attributes and the transformed dataset.

In one embodiment, the generic feature suppression loss may be an estimation of an upper bound of mutual information between the generic feature and the transformed dataset.

In one embodiment, the fourth neural network may be fixed after it is initialized.

According to another embodiment, a system comprising at least one computer including a processor and a memory, wherein the at least one computer may be configured to execute a machine learning model, and wherein the machine learning model may be configured to: provide a data transformation module of the machine learning model, wherein the data transformation module accepts an original dataset as input to a first neural network and a second neural network and outputs a transformed dataset; provide a sensitive attribute suppression module of the machine learning model, wherein the sensitive attribute suppression module accepts the transformed dataset as input to a third neural network and calculates, for each attribute of a plurality of annotated sensitive attributes, a sensitive attribute suppression loss; provide an annotated useful attribute preservation module of the machine learning model, wherein the annotated useful attribute preservation module accepts the transformed dataset as input to a fourth neural network, and calculates, for each attribute of a plurality of annotated useful attributes, a useful attribute preservation loss; provide a generic feature suppression module of the machine learning model that accepts parameters of a distribution of a latent variable from the first neural network and calculates, for an unannotated generic attribute, a generic feature suppression loss; combine the sensitive attribute suppression loss, the useful attribute preservation loss, and the generic feature suppression loss into a total loss; and train the first neural network and the second neural network with the total loss.

In one embodiment, the third neural network may be trained jointly with the training of the first neural network and the second neural network using the sensitive attribute suppression loss, and wherein the third neural network may be trained using supervised learning.

In one embodiment, the first neural network may be trained using gradient descent.

In one embodiment, the sensitive attribute suppression loss may be a constraint to an estimation of mutual information between each attribute of the plurality of annotated sensitive attributes and the transformed dataset.

In one embodiment, the useful attribute preservation loss may be a constraint to an estimation of mutual information between each attribute of a plurality of annotated useful attributes and the transformed dataset.

In one embodiment, the generic feature suppression loss may be an estimation of an upper bound of mutual information between the generic feature and the transformed dataset.

In one embodiment, the fourth neural network may be fixed after it is initialized.

According to another embodiment, a non-transitory computer readable storage medium may include instructions stored thereon, which when read and executed by one or more computer processors, cause the one or more computer processors to perform steps comprising: executing a machine learning model; providing a data transformation module of the machine learning model, wherein the data transformation module accepts an original dataset as input to a first neural network and a second neural network and outputs a transformed dataset; providing a sensitive attribute suppression module of the machine learning model, wherein the sensitive attribute suppression module accepts the transformed dataset as input to a third neural network and calculates, for each attribute of a plurality of annotated sensitive attributes, a sensitive attribute suppression loss; providing an annotated useful attribute preservation module of the machine learning model, wherein the annotated useful attribute preservation module accepts the transformed dataset as input to a fourth neural network, and calculates, for each attribute of a plurality of annotated useful attributes, a useful attribute preservation loss, wherein the fourth neural network may be fixed after it is initialized; providing a generic feature suppression module of the machine learning model that accepts parameters of a distribution of a latent variable from the first neural network and calculates, for an unannotated generic attribute, a generic feature suppression loss; combining the sensitive attribute suppression loss, the useful attribute preservation loss, and the generic feature suppression loss into a total loss; and training the first neural network and the second neural network with the total loss.

In one embodiment, the third neural network may be trained jointly with the training of the first neural network and the second neural network using the sensitive attribute suppression loss, and wherein the third neural network may be trained using supervised learning.

In one embodiment, the first neural network may be trained using gradient descent.

In one embodiment, the sensitive attribute suppression loss may be a constraint to an estimation of mutual information between each attribute of the plurality of annotated sensitive attributes and the transformed dataset.

In one embodiment, the useful attribute preservation loss may be a constraint to an estimation of mutual information between each attribute of a plurality of annotated useful attributes and the transformed dataset.

In one embodiment, the generic feature suppression loss may be an estimation of an upper bound of mutual information between the generic feature and the transformed dataset.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 shows a Markov Chain of random variables, in accordance with aspects.

FIG. 2 depicts a system for generic feature suppression and minimal utility presentation from multi-attribute data according to an embodiment.

FIG. 3 shows a training system for training a neural network, in accordance with aspects.

FIG. 4 shows a logical flow for generic feature suppression and minimal utility presentation from multi-attribute data according to an embodiment.

FIG. 5 is a block diagram of a computing device for implementing certain aspects of the present disclosure.

### DETAILED DESCRIPTION OF PREFERRED EMBODIMENTS

Embodiments are directed to systems and methods for generic feature suppression and minimal utility presentation from multi-attribute data.

The disclosure of U.S. patent application Ser. No. 18/449,426, filed Aug. 14, 2023, is hereby incorporated, by reference, in its entirety.

Embodiments may transform multi-attribute data so that it can only be used for specific applications, and cannot be used to infer other sensitive information. For example, when the dataset is transformed and released, the information released for annotated sensitive attributes and the information preserved for annotated useful attributes are constrained, and the information preserved for generic features is minimized.

Embodiments may selectively suppress sensitive attributes in a dataset while preserving other useful attributes, such that the potential utility of the dataset may be fully exploited without regard to ethical privacy concerns and/or regulatory concerns. Embodiments may incorporate a theoretical proof of suppression/obfuscation of attributes identified as private and may incorporate such theoretical proof into a multi-attribute data transformation platform including a model or series of models such that the platform meets the theoretical proof.

Embodiments may incorporate a constrained optimization problem in one or more machine learning (ML) models, where the machine learning model solves the constrained optimization problem by estimating each component of the problem. For example, embodiments may (1) convert annotated sensitive attributes suppression into constraining the mutual information between transformed data and the sensitive attributes, and may further convert it into constraining the cross entropy between predicted conditional distribution and ground truth of each sensitive attributes; (2) convert annotated useful attributes preservation into constraining the mutual information between transformed data and the useful attributes, and may further convert it into constraining the cross entropy between predicted conditional distribution and ground truth of each useful attributes; (3) convert unannotated generic features suppression into minimizing the mutual information between it and transformed data, and convert it into minimizing the KL divergence between the conditional distribution of latent variables and a unit Gaussian distribution.

Suppression of datapoints having sensitive attributes may be converted into constraining mutual information between transformed data and the sensitive attributes. The output of a data transformation ML model may be transformed data X′. Input to each of a sensitive attribute suppression ML model, an annotated useful attribute preservation ML model, and an unannotated useful attribute preservation model may be X′. Output from each of a sensitive attribute suppression ML model, an annotated useful attribute preservation ML model, and an unannotated useful attribute preservation model may be a loss (i.e., output of a loss function). A data transformation ML model may then be iteratively trained using the loss output from the associated models.

While the term “sensitive,” referring to data, attributes, etc., may be used herein to denote data and/or attributes annotated for obfuscation, it is contemplated that any annotated datapoints may be selected for obfuscation, and that “sensitive” data such as personal, medical, financial, and other non-public data is used herein only as an exemplary use case for obfuscation.

In accordance with aspects, a problem definition of an optimization problem may consider a multi-attribute dataset comprised of original data X, a set of M sensitive attributes S=(S₁, S₂, . . . , S_{M}), a set of N annotated useful attributes U=(U₁, U₂, . . . , U_{N}), and a set of unannotated generic features F. While direct access to the joint distribution of P(X, U, S, F), may not be possible, a set of data points sampled from P(X, U, S) in the dataset may be obtained.

S and U may be assumed to be random variables following finite categorical distributions, allowing the mutual information between S, U, and X to be bounded. Additionally, with the given X, the corresponding annotated attributes S, (are determined (i.e., P(Sᵢ|X) and P(Uⱼ|X) are one-hot vectors). For broad applicability, no assumptions are made regarding the dimension or distribution family for F and X, nor is any independence between/and other variables assumed, which means that/may correlate with the joint distribution of X, S, U.

Accordingly, an optimal data transformation P_{θ,ω}(X′|X) may be sought by solving the constrained optimization problem:

$${min}_{θ , ω} I ( {X}^{′} ; F ) such that I ( {X}^{′} ; {S}_{i} ) \leq {m}_{i} and I ( {X}^{′} ; U ) \geq {n}_{j}$$

where i∈1 . . . . M, and j∈1 . . . N, P_{θ,ω}(X′|X) can be broken down into P_{θ}(Z|X) and X′=g_{ω} (Z), which are parameterized by neural networks θ, ω, respectively. By solving this optimization problem, embodiments may preserve at least nⱼ nats (the counterpart of bits with Napierian base) information for Uⱼ in the transformed data X′, at most mᵢ nats information is leaked for Sᵢ in X′, and the information preserved for F in X′ is minimized.

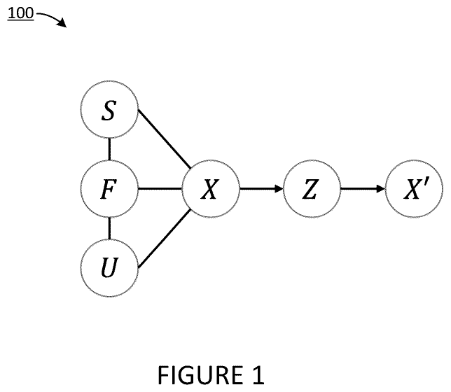

FIG. 1 shows a Markov Chain of random variables, in accordance with aspects. Markov chain 100, as depicted in FIG. 1, is of U, S, F, X, Z, X′ and corresponds to the optimization problem definition, above.

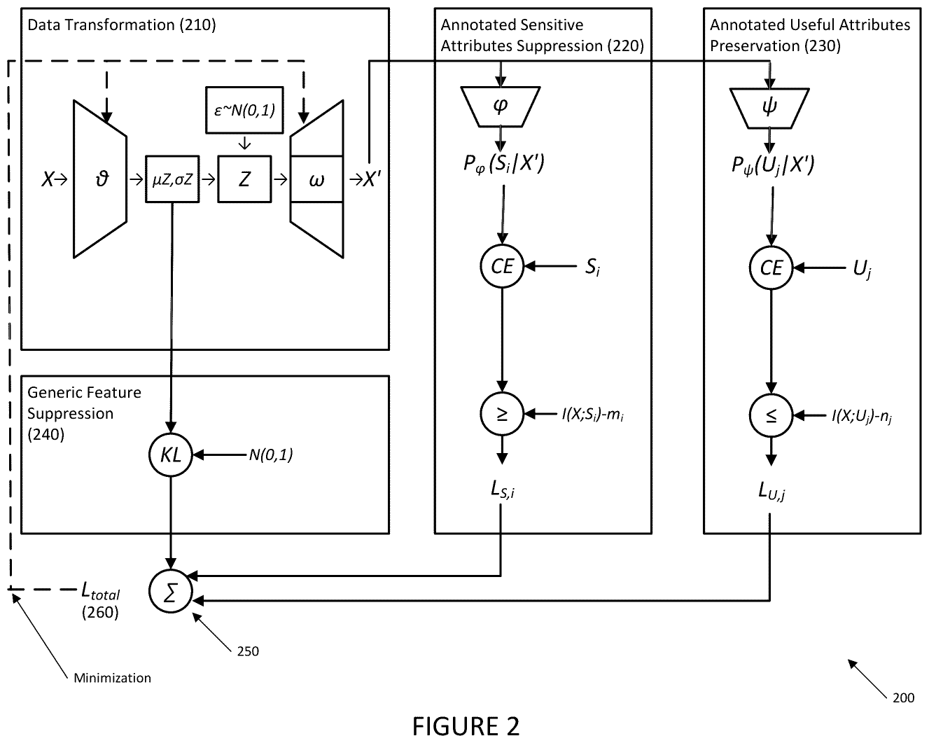

FIG. 2 depicts a system for generic feature suppression and minimal utility presentation from multi-attribute data according to an embodiment. System 200 may include data transformation module 210, annotated sensitive attribute suppression module 220, annotated useful attributes preservation module 230, and generic feature suppression module 240. System 200 additionally depicts summation 250 and total loss 260.

Data transformation module 210 may receive original data X, and may output transformed data X′. Data transformation module 210 may break down the joint distribution P_{θ,ω}(X′|X) into Z˜P_{θ}(Z|X) and X′=g_{ω}(Z), where the joint distribution P_{θ}(Z|X) may be formulated as a fully factorized multi-variate Gaussian distribution [symbol] (μ_{Z}(X), σ_{Z}(X)), where μ_{Z}, σ_{Z} are parameters of the distribution of the latent variable. Z (the latent variable) may be sampled from P_{θ}(Z|X) using a reparameterization method that allows the first neural network e to be trained using gradient descent (e.g., an optimization algorithm for finding a local minimum of a differentiable function).

An example of a reparameterization method is as follows. Embodiments may sample a noise variable e from unit multi-variate Gaussian distribution ϵ˜ [symbol] (0, 1), which serves as the source of randomness for Z. Z may then be deterministically calculated as Z=ϵσ_{Z}(X)+μ_{Z}(X).

Z may then be provided to neural network ω, and the output may be transformed data X′.

Transformed data X′ may be provided to annotated sensitive attribute suppression module 220, and annotated useful attributes preservation module 230. Annotated sensitive attribute suppression module 220 may receive transformed data X′into third neural network ϕ and may output a suppression loss L_{s,i} for the i-th sensitive attribute. The derivation of L_{s,i} is as follows.

Under the assumption that attributes S can be fully determined given X (i.e., P(Sᵢ|X) is a one-hot vector), the mutual information I(X′; Sᵢ) may be reformulated as:

$$\begin{matrix}I ( {X}^{′} ; {S}_{i} ) = {𝔼}_{P ( X ) {P}_{θ , ω} ( {X}^{′} \vert X ) P ( {S}_{i} \vert X )} [ log \frac{P ( {S}_{i} \vert {X}^{′} )}{P ( {S}_{i} )} ] \\ = I ( X ; {S}_{i} ) = {𝔼}_{P ( X ) {P}_{θ , ω} ( {X}^{′} \vert X )} [ H ( P ( {S}_{i} \vert X ) , P ( {S}_{i} \vert {X}^{′} ) ) ] ,\end{matrix}$$

where H(⋅, ⋅) denotes cross-entropy, I(X; Sᵢ) may be calculated before training, and the expectation may be estimated using mini-batch during training. The direct computation of the joint distribution P(Sᵢ|X′) may be infeasible because of the intricate nature of the P_{θ,ω}(X′|X). To address this, P(Sᵢ|X′) may be estimated with a neural network P_{ϕi} (Sᵢ|X′), which is trained adversarially with the first neural network θ using traditional cross-entropy-based supervised learning method:

$${ϕ}_{i} = arg {min}_{{ϕ}_{i}} {𝔼}_{P ( X ) {P}_{θ , ω} ( {X}^{′} \vert X )} [ H ( P ( {S}_{i} \vert X ) , P ( {S}_{i} \vert {X}^{′} ) ) ] .$$

Consequently, the constraint I(X′; Sᵢ)≤mᵢ may be converted to:

$$\vert I ( X ; {S}_{i} ) - {m}_{i} \leq {𝔼}_{P ( X ) {P}_{θ , ω} ( {X}^{′} \vert X )} [ H ( P ( {S}_{i} \vert X ) , {P}_{{ϕ}_{i}} ( {S}_{i} \vert {X}^{′} ) ) ] .$$

Using the penalty method, the constraint may be converted into a quadratic continuous loss function eligible for gradient descent as:

$${d}_{S , i} = min ( {𝔼}_{P ( X ) {P}_{θ , ω} ( {X}^{′} \vert X )} [ H ( P ( {S}_{i} \vert X ) , {P}_{{ϕ}_{i}} ( {S}_{i} \vert {X}^{′} ) ) ] + {m}_{i} - I ( X ; {S}_{i} ) , 0 )$$

$${L}_{S , i} = {d}_{S , i}^{2} + \vert {d}_{S , i} \vert$$

In order to accelerate the training process, an attribute inference network may be pre-trained on original data X for each Sᵢ, denoted as ϕ_{i,0}, using traditional supervised learning. The transformed data attribute inference models ϕᵢ with ϕ_{i,0} may be initialized, so that they can converge faster during training.

Annotated useful attributes presentation module 230 may also receive transformed data X′ into fourth neural network y and may output a preservation loss L_{u,i} for the i-th useful attribute.

Under the assumption that attributes U can be fully determined given X (i.e., P(Uⱼ|X) is a one-hot vector), the constraint I(X′;Uⱼ)≥nⱼ may be reformulated as

$$\begin{matrix}I ( {X}^{′} ; {U}_{j} ) = {𝔼}_{P ( X ) {P}_{θ , ω} ( {X}^{′} \vert X ) P ( {U}_{j} \vert X )} [ log \frac{P ( {U}_{j} \vert {X}^{′} )}{P ( {U}_{j} )} ] \\ = I ( X ; {U}_{j} ) = {𝔼}_{P ( X ) {P}_{θ , ω} ( {X}^{′} \vert X )} [ H ( P ( {U}_{j} \vert X ) , P ( {U}_{j} \vert {X}^{′} ) ) ] ,\end{matrix}$$

where P(Uⱼ|X′) may be approximated with neural network P_{ψj}(Uⱼ|X′).

To ensure that X and X′ are kept in the same sample space so that models pretrained on X can still achieve satisfactory performance on X′ without extra fine-tuning, an attribute inference network may be pre-trained on original data X for each Uⱼ, denoted as ψ_{j,0}, using a traditional supervised learning method. Then, the transformed data attribute inference models; are frozen and initialized with ψ_{j,0}, without further tuning, so that ψ_{j,0} can still perform well on transformed data X′.

The constraint may be further converted into the following loss function using quadratic penalty method:

$${d}_{U , i} = min ( {𝔼}_{P ( X ) {P}_{θ , ω} ( {X}^{′} \vert X )} [ H ( P ( {U}_{j} \vert X ) , {P}_{{ϕ}_{i}} ( {U}_{j} \vert {X}^{′} ) ) ] + {m}_{i} - I ( X ; {U}_{j} ) , 0 )$$

$${L}_{U , j} = {d}_{U , j}^{2} + \vert {d}_{U , j} \vert$$

Generic feature suppression module 240 accepts the parameters of the distribution of the latent variable μ_{Z}, σ_{Z} from the first neural network in data transformation module 210 and calculates, for the unannotated generic attribute F, a generic feature suppression loss.

The generic feature suppression loss may be an estimation of an upper bound of mutual information between the generic feature and the transformed dataset. It is a measure of how much sensitive information (of unannotated generic features) is leaked. The generic feature suppression loss may be minimized to train the neural network.

Without assumptions on the distribution family of F and X′, approximating I(X′; F) using methods mentioned above is not feasible. As an alternative, embodiments may minimize I(X′; F) by minimize its upper bound L_{F} derived using a variational method:

$${min}_{θ} {L}_{F} = KL ( {P}_{θ} ( Z \vert X ) ‖ Q ( Z ) )$$

where P_{θ}(Z|X) is a fully factorized multi-variate Gaussian distribution [symbol] (μ_{Z}(X), and θ_{Z}(X)), Q(Z) is a multi-variate unit Gaussian distribution of Z. Consequently, K_{L}(P_{θ}(Z|X)∥Q(Z)) is tractable and may be calculated analytically. It can also be proven as an upper bound of I(X′; F).

Summation 250 represents the sum or totaling of the outputs from annotated sensitive attribute suppression module 220, annotated useful attribute preservation module 230, and generic feature suppression module 240 into total loss 260. The constrained optimization problem may be converted into a differentiable optimization problem ready for gradient descent:

$${min}_{θ , ω} {L}_{total} = {L}_{F} + λ ( {\sum }_{i} {L}_{S , i} + {\sum }_{j} {L}_{U , j} )$$

where λ is a hyper parameter controlling the degree of relaxation. When λ→∞, the differentiable optimization problem recovers the constrained optimization problem.

Total loss 260 may be used to train first neural networks θ and second neural network w of data transformation module 210.

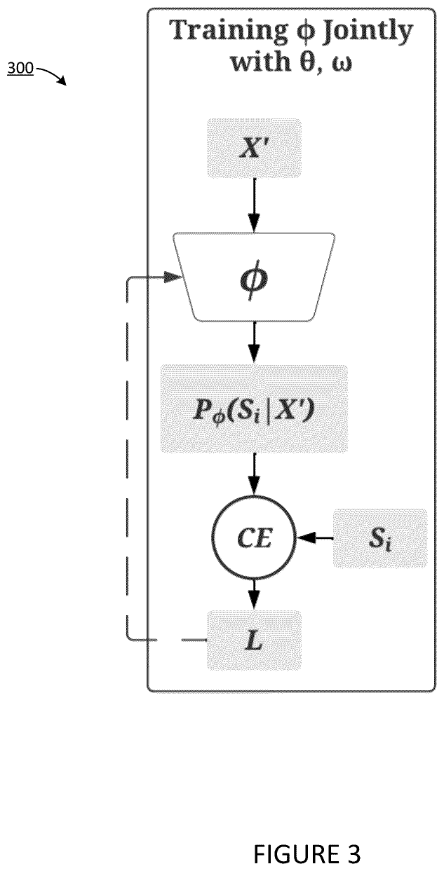

FIG. 3 shows a training system for training third neural network ϕ according to embodiments. Training system 300 depicts training of third neural network ϕ using a traditional supervised learning method. Training of third neural network ϕ may be performed jointly with the training of the first neural network e and the second neural network ω. “CE” in training system 300 denotes cross-entropy. The dashed line in FIG. 3 represents minimization.

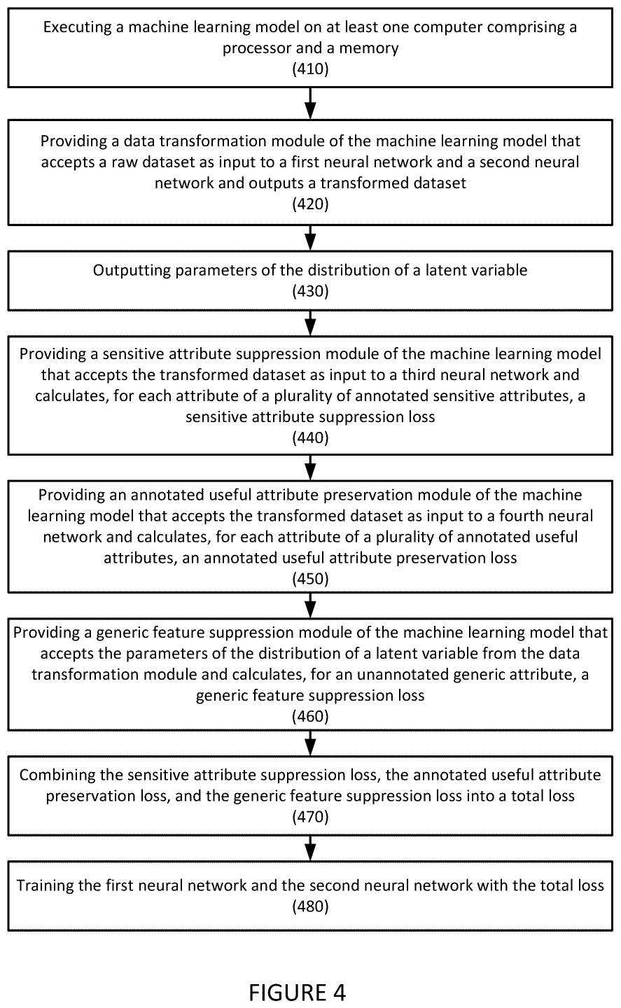

FIG. 4 depicts a logical flow for providing privacy protection and utility preservation in multi-attribute data transformation with theoretical proofs according to an embodiment.

Step 410 includes providing a machine learning model that executes on at least one computer comprising a memory and a processor.

Step 420 includes providing a data transformation module of the machine learning model that accepts a raw dataset as an input to a first neural network θ and a second neural network ω, and outputs a transformed dataset to an annotated sensitive attribute suppression module and an annotated useful attribute preservation module.

In step 430, the first neural network may output parameters of the distribution of a latent variable for a generic feature suppression module.

Step 440 includes providing an annotated sensitive attribute suppression module of the machine learning model with the transformed dataset. The annotated sensitive attribute suppression module accepts the transformed dataset as input to a third neural network ϕ and calculates, for each attribute of a plurality of annotated sensitive attributes S, a sensitive attribute suppression loss.

The sensitive attribute suppression loss may be a constraint on an estimation of mutual information between each attribute of the plurality of annotated sensitive attributes and the transformed dataset. It is a measure of how much more sensitive information (of annotated attributes) is leaked than an acceptable standard. The higher this loss is, the more sensitive information is leaked. Embodiments may minimize the sensitive attribute suppression loss to train the neural network.

Step 450 includes providing an annotated useful attribute preservation module of the machine learning model. The annotated useful attribute preservation module accepts the transformed dataset as input to a fourth neural network v, and calculates, for each attribute of a plurality of annotated useful attributes U, an annotated useful attribute preservation loss.

The annotated useful attribute preservation loss may be a constraint on an estimation of mutual information between each attribute of a plurality of annotated useful attributes and the transformed dataset. It is a measure of how much less useful information (of annotated attributes) is preserved than an acceptable standard. The higher this loss is, the less useful information is preserved. Embodiments may minimize the annotated useful attribute preservation loss to train the neural network.

Step 460 includes providing a generic feature suppression module of the machine learning model. The generic feature suppression module accepts the latent variable from the data transformation module and calculates, for an unannotated generic attribute/′, a generic feature suppression loss.

Step 470 includes combining the sensitive attribute suppression loss, the annotated useful attribute preservation loss, and the generic feature suppression loss into a total loss.

Step 480 includes training the first neural network and the second neural network using the total loss.

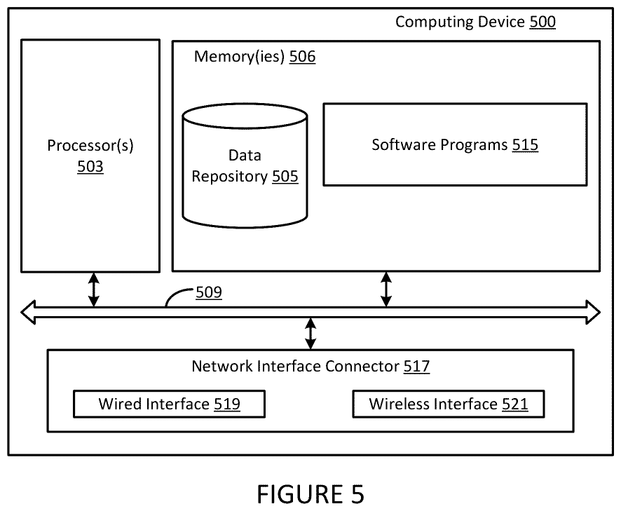

FIG. 5 is a block diagram of a computing device for implementing certain aspects of the present disclosure. FIG. 5 depicts exemplary computing device 500. Computing device 500 may represent hardware that executes the logic that drives the various system components described herein. For example, system components such as a machine learning model and the various modules including neural networks thereof, a ML model training processes as described herein, an interface, various database engines and database servers, and other computer applications and logic may include, and/or execute on, components and configurations like, or similar to, computing device 500.

Computing device 500 includes a processor 503 coupled to a memory 506. Memory 506 may include volatile memory and/or persistent memory. The processor 503 executes computer-executable program code stored in memory 506, such as software programs 515. Software programs 515 may include one or more of the logical steps disclosed herein as a programmatic instruction, which can be executed by processor 503. Memory 506 may also include data repository 505, which may be nonvolatile memory for data persistence. The processor 503 and the memory 506 may be coupled by a bus 509. In some examples, the bus 509 may also be coupled to one or more network interface connectors 517, such as wired network interface 519, and/or wireless network interface 521. Computing device 500 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” a “computer,” an “electronic device,” a “mobile device,” etc. These may be a computer, a computer server, a host machine, etc. As used herein, the term “processing machine,” “computing device, “computer,” “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above, including any logical stops or logical flows described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

What is claimed is:

1. A method comprising:
executing a machine learning model on at least one computer comprising a processor and a memory;
providing a data transformation module of the machine learning model, wherein the data transformation module accepts an original dataset as input to a first neural network and a second neural network and outputs a transformed dataset;
providing a sensitive attribute suppression module of the machine learning model, wherein the sensitive attribute suppression module accepts the transformed dataset as input to a third neural network and calculates, for each attribute of a plurality of annotated sensitive attributes, a sensitive attribute suppression loss;
providing an annotated useful attribute preservation module of the machine learning model, wherein the annotated useful attribute preservation module accepts the transformed dataset as input to a fourth neural network, and calculates, for each attribute of a plurality of annotated useful attributes, a useful attribute preservation loss;
providing a generic feature suppression module of the machine learning model that accepts parameters of a distribution of a latent variable from the first neural network and calculates, for an unannotated generic attribute, a generic feature suppression loss;
combining the sensitive attribute suppression loss, the useful attribute preservation loss, and the generic feature suppression loss into a total loss; and
training the first neural network and the second neural network with the total loss.

2. The method of claim 1, wherein the third neural network is trained jointly with the training of the first neural network and the second neural network using the sensitive attribute suppression loss, and wherein the third neural network is trained using supervised learning.

3. The method of claim 1, wherein the first neural network is trained using gradient descent.

4. The method of claim 1, wherein the sensitive attribute suppression loss is a constraint to an estimation of mutual information between each attribute of the plurality of annotated sensitive attributes and the transformed dataset.

5. The method of claim 1, wherein the useful attribute preservation loss is a constraint to an estimation of mutual information between each attribute of a plurality of annotated useful attributes and the transformed dataset.

6. The method of claim 1, wherein the generic feature suppression loss is an estimation of an upper bound of mutual information between the generic feature and the transformed dataset.

7. The method of claim 1, wherein the fourth neural network is fixed after it is initialized.

8. A system comprising at least one computer including a processor and a memory, wherein the at least one computer is configured to execute a machine learning model, and wherein the machine learning model is configured to:
provide a data transformation module of the machine learning model, wherein the data transformation module accepts an original dataset as input to a first neural network and a second neural network and outputs a transformed dataset;
provide a sensitive attribute suppression module of the machine learning model, wherein the sensitive attribute suppression module accepts the transformed dataset as input to a third neural network and calculates, for each attribute of a plurality of annotated sensitive attributes, a sensitive attribute suppression loss;
provide an annotated useful attribute preservation module of the machine learning model, wherein the annotated useful attribute preservation module accepts the transformed dataset as input to a fourth neural network, and calculates, for each attribute of a plurality of annotated useful attributes, a useful attribute preservation loss;
provide a generic feature suppression module of the machine learning model that accepts parameters of a distribution of a latent variable from the first neural network and calculates, for an unannotated generic attribute, a generic feature suppression loss;
combine the sensitive attribute suppression loss, the useful attribute preservation loss, and the generic feature suppression loss into a total loss; and
train the first neural network and the second neural network with the total loss.

9. The system of claim 8, wherein the third neural network is trained jointly with the training of the first neural network and the second neural network using the sensitive attribute suppression loss, and wherein the third neural network is trained using supervised learning.

10. The system of claim 8, wherein the first neural network is trained using gradient descent.

11. The system of claim 8, wherein the sensitive attribute suppression loss is a constraint to an estimation of mutual information between each attribute of the plurality of annotated sensitive attributes and the transformed dataset.

12. The system of claim 8, wherein the useful attribute preservation loss is a constraint to an estimation of mutual information between each attribute of a plurality of annotated useful attributes and the transformed dataset.

13. The system of claim 8, wherein the generic feature suppression loss is an estimation of an upper bound of mutual information between the generic feature and the transformed dataset.

14. The system of claim 8, wherein the fourth neural network is fixed after it is initialized.

15. A non-transitory computer readable storage medium, including instructions stored thereon, which when read and executed by one or more computer processors, cause the one or more computer processors to perform steps comprising:
executing a machine learning model;
providing a data transformation module of the machine learning model, wherein the data transformation module accepts an original dataset as input to a first neural network and a second neural network and outputs a transformed dataset;
providing a sensitive attribute suppression module of the machine learning model, wherein the sensitive attribute suppression module accepts the transformed dataset as input to a third neural network and calculates, for each attribute of a plurality of annotated sensitive attributes, a sensitive attribute suppression loss;
providing an annotated useful attribute preservation module of the machine learning model, wherein the annotated useful attribute preservation module accepts the transformed dataset as input to a fourth neural network, and calculates, for each attribute of a plurality of annotated useful attributes, a useful attribute preservation loss, wherein the fourth neural network is fixed after it is initialized;
providing a generic feature suppression module of the machine learning model that accepts parameters of a distribution of a latent variable from the first neural network and calculates, for an unannotated generic attribute, a generic feature suppression loss;
combining the sensitive attribute suppression loss, the useful attribute preservation loss, and the generic feature suppression loss into a total loss; and
training the first neural network and the second neural network with the total loss.

16. The non-transitory computer readable storage medium of claim 15, wherein the third neural network is trained jointly with the training of the first neural network and the second neural network using the sensitive attribute suppression loss, and wherein the third neural network is trained using supervised learning.

17. The non-transitory computer readable storage medium of claim 15, wherein the first neural network is trained using gradient descent.

18. The non-transitory computer readable storage medium of claim 15, wherein the sensitive attribute suppression loss is a constraint to an estimation of mutual information between each attribute of the plurality of annotated sensitive attributes and the transformed dataset.

19. The non-transitory computer readable storage medium of claim 15, wherein the useful attribute preservation loss is a constraint to an estimation of mutual information between each attribute of a plurality of annotated useful attributes and the transformed dataset.

20. The non-transitory computer readable storage medium of claim 15, wherein the generic feature suppression loss is an estimation of an upper bound of mutual information between the generic feature ‘and the transformed dataset.
